(19) United States
(12) Patent Application Publication
(10) Pub. No.: US 2026/0177981 A1
(43) Pub. Date: Jun. 25, 2026

(54) CERAMISED COMPONENT WITH DECORATION AND ITS MANUFACTURING METHOD

(71) Applicant: Comadur SA, Le Locle (CH)

(72) Inventors: Pierry VUILLE, Les Emibois (CH); Johan ROMAND, Mamirolle (FR)

(73) Assignee: Comadur SA, Le Locle (CH)

(21) Appl. No.: 19/412,373

(22) Filed: Dec. 8, 2025

(30) Foreign Application Priority Data
Dec. 20, 2024 (EP) 24222407.9

(51) Int. Cl. G04B 19/12; G04B 19/18; G04B 45/00

(52) U.S. Cl. CPC G04B 19/12; G04B 19/18; G04B 45/0076

(57) ABSTRACT

A decorated piece including a substrate (1) with a surface (1a) defining a first part with a positive and/or negative relief (2) relative to the plane of the surface (1a) and a second part extending in the plane of the surface (1a), the first or second parts forming a decoration (4), wherein the first part is formed from the substrate (1) made of an amorphous zirconium-based metallic alloy and in that the second part is formed from a ceramic layer (3) deposited on the substrate (1) or, conversely, in that the first part is formed from the ceramic layer (3) deposited on the substrate (1) and in that the second part is formed of the substrate (1) made of the amorphous zirconium-based metallic alloy. Also, a method for manufacturing the decorated piece.

### CROSS-REFERENCE TO RELATED APPLICATIONS

This application claims priority to European Patent Application No. 24222407.9, filed on Dec. 20, 2024, the entire contents of which are incorporated herein by reference.

### TECHNICAL FIELD OF THE INVENTION

The present invention relates to a decorated piece, particularly a horology component, made of two materials, with an amorphous metallic alloy substrate comprising a ceramic layer on part of its surface. It also relates to the method used to manufacture the piece.

### TECHNOLOGICAL BACKGROUND

Decorated horology components pairing amorphous metal and ceramic as constituent materials are available in the prior art. The components are currently made with a ceramic substrate inlaid with an amorphous metal decoration. One technique consists of engraving the ceramic horology component and then inlaying the amorphous metal.

Using a ceramic substrate for these horology components has several drawbacks. Firstly, preparing the ceramic substrate is time-consuming and expensive. Secondly, ceramic is a brittle material that does not withstand deflection well. This can lead to breakage during the manufacturing process or when fitting the component on the case.

Another technique consists of producing positive amorphous metal indexes on ceramic substrates. This is done by galvanic growth of the copper that acts as the die during the inlaying step, which is then dissolved with acid. This method is very complex and expensive and is therefore reserved for very small production runs. Moreover, the fragility of the ceramic substrate remains an issue.

### SUMMARY OF THE INVENTION

The invention aims to remedy the aforementioned drawbacks by providing a decorative, dual-material component with an inverted arrangement of materials so as to avoid the drawbacks associated with handling brittle ceramics and to make the method easier to use.

To this end, it is proposed to start from an amorphous metallic alloy substrate with a part of the surface of the substrate comprising a ceramic layer, with either the amorphous metallic alloy or the ceramic forming the decoration.

More specifically, invention relates to a decorated piece comprising a substrate with a surface defining a first part with a positive and/or negative relief relative to the plane of the surface and a second part extending in the plane of the surface, the first or second parts forming a decoration, the decorated piece being characterised in that the first part is formed from the substrate made of an amorphous zirconium-based metallic alloy and in that the second part is formed from a ceramic layer deposited on the substrate or, conversely, being characterised in that the first part is formed from said ceramic layer deposited on the substrate and in that the second part is formed of said substrate made of the amorphous zirconium-based metallic alloy.

Compared with a one-piece ceramic piece, the same aesthetic appearance and surface hardness can be achieved while eliminating the brittle behaviour of the material. For example, with a ceramic middle, a horn can easily break off in a fall, resulting in the loss of the wristlet. In the case of amorphous metal with a ceramic layer, there will be no breakage of the horns in the event of a fall.

Using amorphous metal as a substrate has many other advantages. Amorphous metal results in a much more homogeneous current for ceramisation than ceramic or conventional metal, due to the absence of flaws in the material. In the case of electrolytic deposition, the quality of the layer created will be far superior to that of any conventional metal deposition. This would make it possible to grow dense layers that are several tenths of a millimetre thicker than with current methods. Another advantage is that the substrate can be produced at lower cost. Indeed, machining amorphous metals such as zirconium is much easier and faster than machining ceramic or crystalline zirconium. Moreover, these materials can be injected or stamped in large production runs to further reduce manufacturing costs. Compared with crystalline zirconium, amorphous zirconium is less expensive to use, as the substrate with the relief can be produced by direct injection or by injection followed by hot pressing, which is impossible with metallic zirconium which would require 100% machining. However, machining zirconium is very expensive due to the material's high flammability and the need to use expensive tools.

Furthermore, the expansion coefficients of amorphous zirconium and ceramics are very similar, which means that thick layers can be grown without the risk of shear delamination. Ceramic, in particular ZrO₂, offers excellent adhesion to amorphous zirconium-based metallic alloys, providing good wear resistance. In addition, corrosion associated with redox potential deltas is also very low for the amorphous zirconium—ZrO2 pairing.

The present invention also relates to the method for manufacturing the piece. More specifically, it relates to a method for manufacturing a decorated piece comprising the following steps:
preparing a substrate made of a zirconium-based amorphous metallic alloy, said substrate comprising a surface defining a first part with a positive and/or negative relief relative to the plane of the surface and a second part extending in the plane of the surface, the first part or the second part being designed to form a decoration,
depositing a ceramic layer on at least a portion of the first part and of the second part or converting the substrate into a ceramic layer on at least a portion of the first part and of the second part,
removing the surplus from the ceramic layer on said portion to obtain the first part formed from the substrate and the second part formed from a ceramic layer deposited on the substrate or conversely to obtain the first part formed from said ceramic layer deposited on the substrate and the second part formed from said substrate, with the first part or the second part forming the decoration.

The range of components to be manufactured is extremely varied, and the method according to the invention enables complex geometries to be produced that would not have been possible with ceramic as the substrate. These can be external parts, but also functional components of the movement that require the mechanical strength of amorphous metal and the hardness of ceramic.

Other purposes, advantages and characteristics of the invention will become clearer from the following detailed description, with reference to the appended drawings.

### BRIEF DESCRIPTION OF THE FIGURES

FIG. 1(a)(b)(c) schematically shows the successive steps in the manufacturing method for a piece with an amorphous metallic alloy decoration flush with the surface, the amorphous metallic alloy decoration being framed by a ceramic layer.

FIG. 2(a)(b)(c) schematically shows the successive steps in the manufacturing method for a piece with a ceramic decoration flush with the surface, the ceramic decoration being framed by an amorphous metallic alloy layer.

FIG. 3(a)(b)(c) shows a variant of the method in FIG. 1 with a positive decoration.

FIG. 4(a)(b)(c) shows a variant of the method in FIG. 2 with negative decoration.

### DETAILED DESCRIPTION OF THE INVENTION

The present invention relates to a method for manufacturing a decorated piece and to the decorated piece. The piece is formed from a zirconium-based amorphous metallic alloy substrate with a decoration that is either ceramic or made of the same amorphous metallic alloy as the substrate. The piece can in particular be an external part used in horology, such as a middle, a back, a bezel, a button, a wristlet link, a flange, a dial, a hand, a dial index, an oscillating mass, etc., or a component of the movement such as a plate, a bar or a balance. The invention will be illustrated below for a bezel 5. The amorphous zirconium-based metallic alloy can be any alloy such as LM1b, LM1b-X- and Vit106a. The ceramic can be an oxide, a nitride or a carbide. Preferentially, it is a zirconium oxide (ZrO₂).

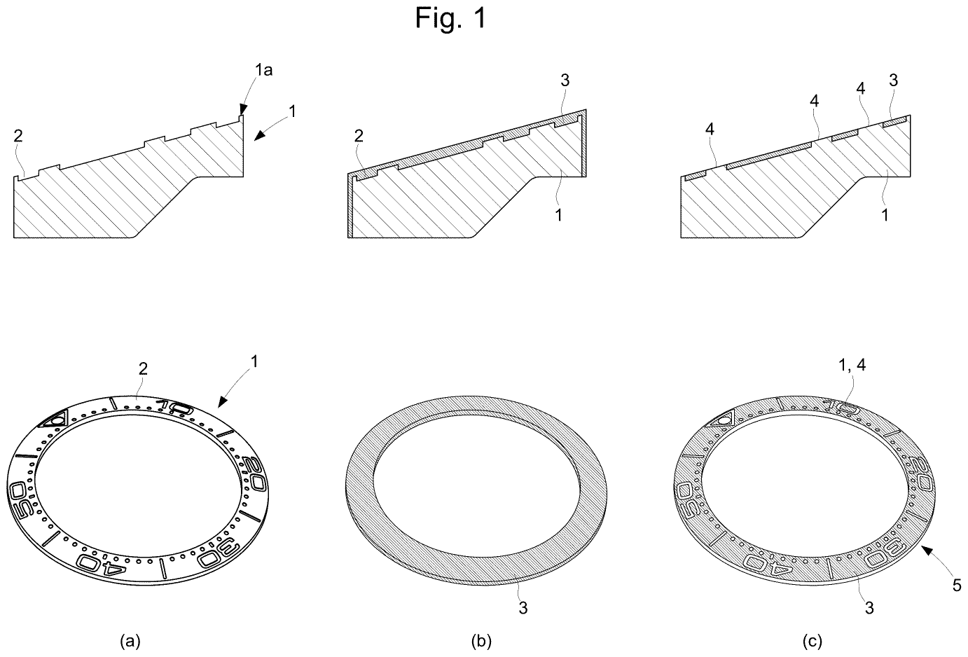

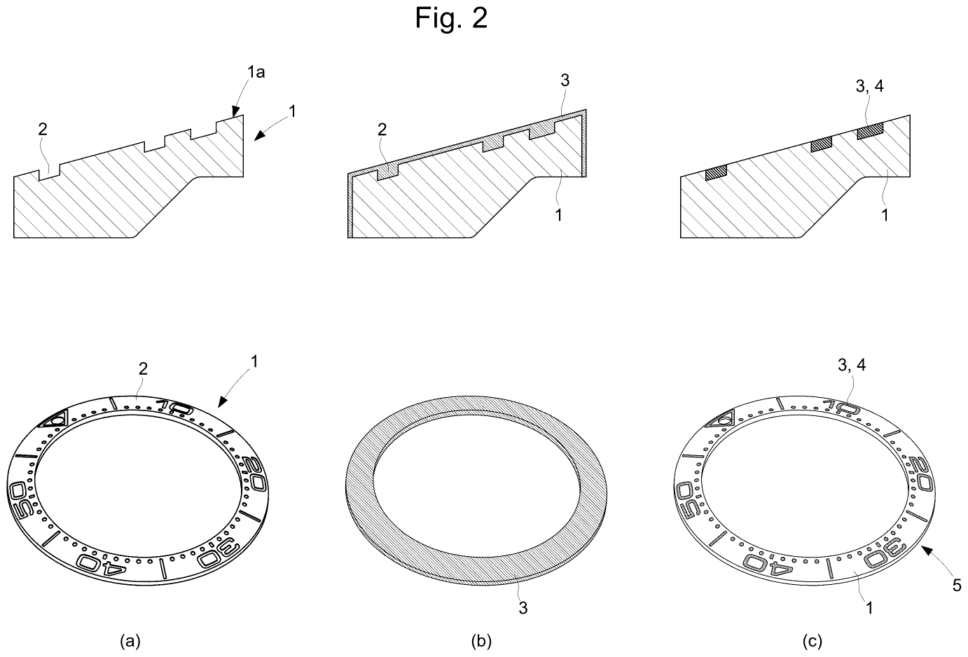

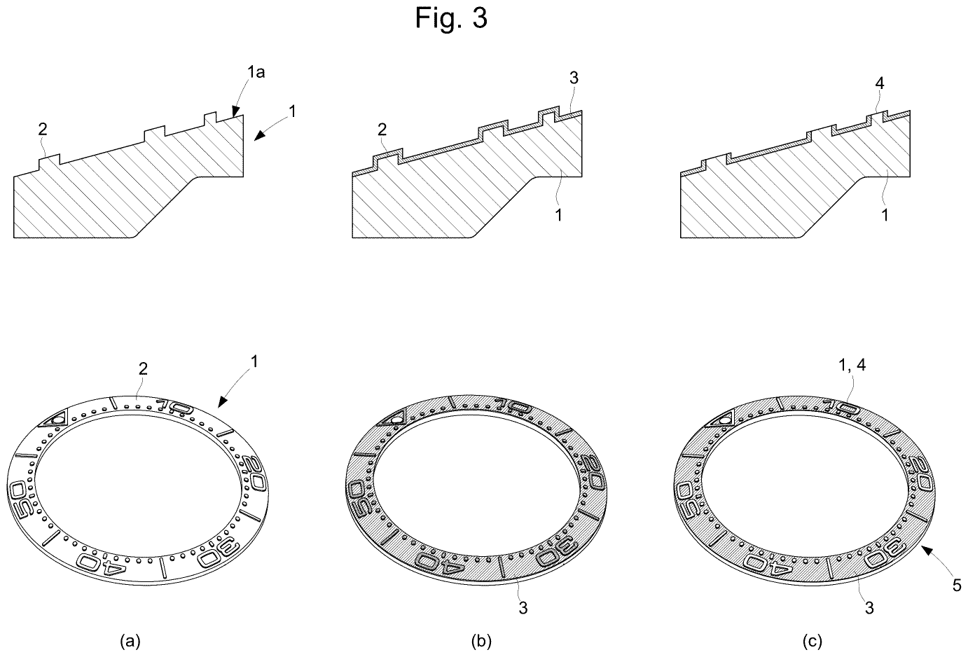

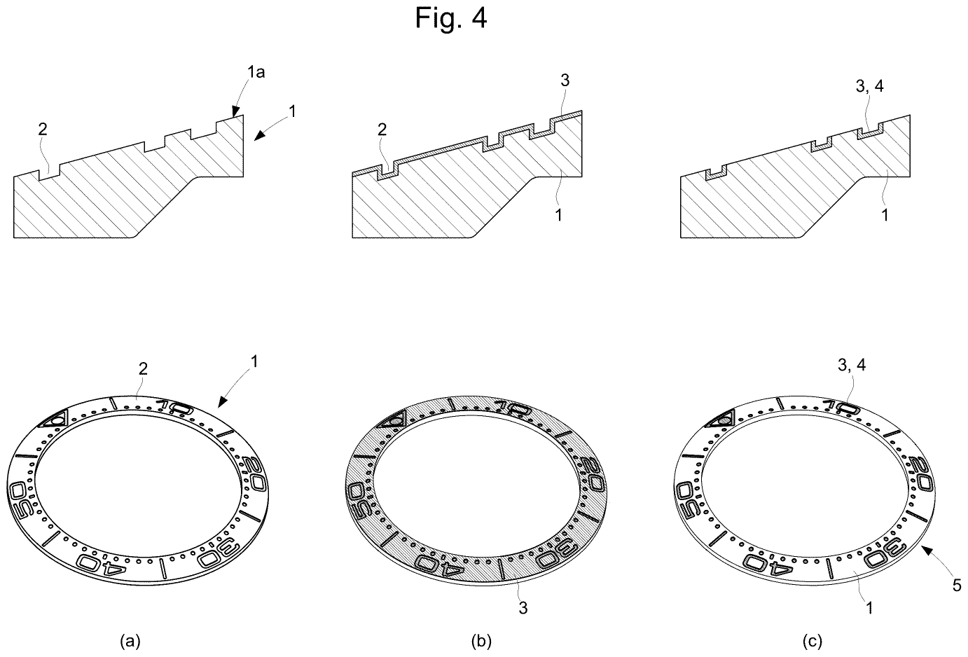

The method enables decorations 4 to be made flush with the surface as illustrated in FIGS. 1 and 2, either positive as illustrated in FIG. 3 or negative as illustrated in FIG. 4. Positive and negative decorations can also be created on the piece. The decoration 4 can be made of amorphous metallic alloy 1 in one piece with the substrate, as shown in FIGS. 1 and 3, or of ceramic 3, as shown in FIGS. 2 and 4. The surface 1a of the substrate 1 has at least one decoration 4 with said amorphous metallic alloy 1 or ceramic 3 decoration. In the case of a decoration 4 made of amorphous metallic alloy 1, it is surrounded by the ceramic layer 3. It should be noted that the flanks of the decoration 4 can be made of ceramic 3 as shown in the example in FIG. 3. In the case of a decoration 4 made of ceramic 3, it is surrounded by the amorphous metallic alloy substrate 1.

According to the invention, ceramisation is carried out by depositing a ceramic layer (oxides, carbides or nitrides) or by converting the amorphous zirconium-based metallic alloy into a layer of zirconium oxides. The conversion is carried out using Micro Arc Oxidation (MAO) or Plasma Electrolytic Oxidation (PEO) techniques. For these techniques, the thickness of the oxide layer is typically about 15 to 20 μm. The ceramic layer can be deposited by electron-beam evaporation and by atomic layer deposition (ALD) with a layer thickness of approximately 10 to 15 nm, or by plasma projection with a thicker layer of approximately 0.10 to 0.20 mm.

The method for making the piece with the decoration 4 is as follows. In a first step (a) which can be seen in FIG. 1(a), 2(a), 3(a) and 4(a), the substrate 1 made from the amorphous zirconium-based metallic alloy is prepared. Preferentially, the substrate is made by injection with or without the reliefs for the decoration. The injection method makes it possible to control the rapid cooling, which ensures that there are no crystallites in the material. If reliefs are not produced during the injection moulding process, they can be formed by hot-pressing the substrate onto a die with the desired shape or conventionally machined by milling or grinding.

In the illustrated examples, the substrate is a bezel ebauche with indexes to be decorated. This substrate 1 has a relief 2 on its surface 1a. In the variants in FIGS. 1, 2 and 4, the relief 2 is formed of recesses cut into the substrate. In other words, the relief 2 is negative relative to the plane of the surface 1a of the substrate. In the variant in FIG. 3, the relief 2 forms a structure overlying the plane of the surface 1a of the substrate. In other words, the relief 2 is positive relative to the plane of the surface 1a of the substrate.

In a second step (b), a ceramic layer 3 is deposited or formed by conversion on all or part of the surface 1a, and optionally on the flanks of the substrate. During the ceramisation process, certain zones on the surface can be hidden so that only the desired zones are ceramised. Depending on the thickness of the deposited or converted layer, all or part of the recesses can be filled, and if there is a structure overlying the plane of the surface, said structure is also covered.

In a third step (c), the surplus ceramic 3 is removed, for example by machining, to reveal, on the surface 1a, the substrate 1 at the level of the decorations 4 or next to the decorations 4 for respectively an amorphous metal alloy decoration 4 or a ceramic decoration. Optionally, surplus amorphous metallic alloy can also be removed.

This produces the piece, particularly the bezel 5, with the indexes forming the decoration 4 either in ceramic 3 or in amorphous metallic alloy 1.

1. A decorated piece comprising a substrate (1) with a surface (1a) defining a first part with a positive and/or negative relief (2) relative to the plane of the surface (1a) and a second part extending in the plane of the surface (1a), the first part or the second part forming a decoration (4),
wherein the first part is formed from the substrate (1) made of an amorphous zirconium-based metallic alloy and in that the second part is formed from a ceramic layer (3) deposited on the substrate (1) or, conversely, the first part is formed from said ceramic layer (3) deposited on the substrate (1) and in that the second part is formed of said substrate (1) made of the amorphous zirconium-based metallic alloy.

2. The decorated piece according to claim 1, wherein the ceramic layer (3) is a layer of zirconium oxide.

3. The decorated piece according to claim 1, wherein the decoration (4) is flush with the plane of the surface (1a), is positive relative to the plane of the surface (1a), or is negative relative to the plane of the surface (1a).

4. The decorated piece according to claim 1, wherein the decorated piece is a horology component.

5. The piece according to claim 1, wherein the decorated piece is a bezel (5) or a dial.

6. A method for manufacturing a decorative piece comprising the following steps:
preparing a substrate (1) made of a zirconium-based amorphous metallic alloy, said substrate (1) comprising a surface (1a) defining a first part with a positive and/or negative relief (2) relative to the plane of the surface (1a) and a second part extending in the plane of the surface (1a), the first part or the second part being designed to form a decoration (4),
depositing a ceramic layer (3) on at least a portion of the first part and of the second part or converting the substrate (1) into a ceramic layer (3) on at least a portion of the first part and of the second part,
removing the surplus from the ceramic layer (3) on said portion to obtain the first part formed from the substrate (1) and the second part formed from the ceramic layer (3) deposited on the substrate (1) or conversely to obtain the first part formed from said ceramic layer (3) deposited on the substrate (1) and the second part formed from said substrate (1), with the first part or the second part forming the decoration (4).

7. The method according to claim 6, wherein the ceramic layer (3) is a layer of zirconium oxide.
